(19) United States
(12) Patent Application Publication
(10) Pub. No.: US 2023/0306194 A1
(43) Pub. Date: Sep. 28, 2023

(54) EXTENSIBLE FRAMEWORK FOR GENERATING ACCESSIBLE CAPTIONS FOR DATA VISUALIZATIONS

(71) Applicant: ADOBE INC., SAN JOSE, CA (US)

(72) Inventors: Fan Du, Milpitas, CA (US); Cameron Elise Womack, Brooklyn, NY (US); Dylan Robert Kario, Los Angeles, CA (US); Molly Josette Bloom, Oakland, CA (US); Elizabeth Waters, San Francisco, CA (US); Matthew Samuel Deutsch, Seattle, WA (US); Ryan Wilkes, Grass Valley, CA (US); Yeuk-Yin Chan, Santa Clara, CA (US); Eunyee Koh, San Jose, CA (US); Andrew Douglas Thomson, Moraga, CA (US); Cole Edward Connelly, San Jose, CA (US); Saurabh Mahapatra, Sunnyvale, CA (US); Vasanthi Holtcamp, Fremont, CA (US)

(21) Appl. No.: 17/656,254

(22) Filed: Mar. 24, 2022

(51) Int. Cl. G06F 40/186; G06F 40/143; G06F 40/177; G06K 9/62; G06N 5/02; G06N 5/00

(52) U.S. Cl. CPC G06F 40/186; G06F 40/143; G06F 40/177; G06K 9/6218; G06N 5/025; G06N 5/003

(57) ABSTRACT

Systems and methods for data processing are described. Example embodiments include identifying chart data corresponding to a visual element of a user interface; selecting an insight type based on a chart category of the chart data; generating insight data for the insight type based on the chart data using a statistical measure corresponding to the insight type; generating an insight caption for the insight type by combining the insight data with a sentence template corresponding to the insight type; and communicating the insight caption to a user of the user interface.

### BACKGROUND

The following relates generally to data processing, and more specifically to data summarization.

Data processing refers generally to the use of a computer to parse, modify, store, and transform data into different forms. Data summarization, which is a type of data processing, can encode complex data into intuitive representations to facilitate discovery and communication of data insights. In some cases, data summarization may include generating charts such as bar charts, pie charts, timeseries charts, etc. The types of visualizations generated may be configured by a user, or a system may recognize the data to be visualized and generate an appropriate visualization type.

However, some users may need assistance in interpreting salient points of information about data, including data represented in charts and graphs. For example, a user may be visually impaired, or unfamiliar with how to interpret a graph. Further, such charts or graphs may lack specificity. Therefore, there is a need in the art for data summarization systems that can generate salient, comprehensible, and accessible summarizations.

### SUMMARY

The present disclosure describes systems and methods for data processing, and specifically, for data summarization. A method according to at least one embodiment of the present disclosure includes selecting chart data corresponding to a visual element of a user interface and identifying a chart category for the data. The method further includes selecting an insight type corresponding to the chart category. Then, insight data for the insight type is generated by applying statistical measures and operations to the chart data, based on the selected insight type. A memory or database provides a sentence template corresponding to the insight type. An insight caption is generated by combining the sentence template with the insight data. This insight caption is then communicated to a user. For example, the caption may be presented as textual information, or read aloud depending on settings of the user interface.

A method, apparatus, non-transitory computer readable medium, and system for data processing are described. One or more aspects of the method, apparatus, non-transitory computer readable medium, and system include identifying chart data corresponding to a visual element of a user interface; selecting an insight type based on a chart category of the chart data; generating insight data for the insight type based on the chart data using a statistical measure corresponding to the insight type; generating an insight caption for the insight type by combining the insight data with a sentence template corresponding to the insight type; and communicating the insight caption to a user of the user interface.

A method, apparatus, non-transitory computer readable medium, and system for data processing are described. One or more aspects of the method, apparatus, non-transitory computer readable medium, and system include receiving chart data; determining that the chart data corresponds to a distribution category; generating grouped values by grouping values of the chart data using a one-dimensional distribution clustering algorithm based on the determination; generating an insight caption by combining the grouped values with a sentence template corresponding to the distribution category; and displaying the caption component in a user interface.

An apparatus, system, and method for data processing are described. One or more aspects of the apparatus, system, and method include a categorization component configured to select a chart category from a plurality of chart categories based on chart data using a rule-based heuristic; an insight detection component configured to generate insight data for an insight type based on the chart data and the chart category using a statistical measure corresponding to the insight type; a filtering component configured to filter a plurality of insights based on a ranking of the plurality of insights; a caption component configured to generate an insight caption for the insight type based on the insight data and the filtering; and a user interface configured to communicate the caption component to a user.

### BRIEF DESCRIPTION OF THE DRAWINGS

FIG. 1 shows an example of a method for caption generation according to aspects of the present disclosure.

FIG. 2 shows an example of chart processing according to aspects of the present disclosure.

FIG. 3 shows an example of a method for data processing according to aspects of the present disclosure.

FIG. 4 shows an example of a method for selecting an insight type according to aspects of the present disclosure.

FIG. 5 shows an example of a method for generating insight data according to aspects of the present disclosure.

FIG. 6 shows an example of a method for generating an insight caption according to aspects of the present disclosure.

FIG. 7 shows an example of a method for data processing according to aspects of the present disclosure.

FIG. 8 shows an example of generating grouped values according to aspects of the present disclosure.

FIG. 9 shows an example of a data processing system according to aspects of the present disclosure.

FIG. 10 shows an example of a data processing apparatus according to aspects of the present disclosure.

### DETAILED DESCRIPTION

Embodiments of the present disclosure relate generally to data processing, and more specifically to data summarization. In some embodiments, one or more captions are generated that summarize key information from a chart or graph.

In some cases, dashboard tools allow chart authors to manually annotate or write captions for a chart, which can be easily consumed by users with screen readers and users who are not skilled at chart interpretation. However, this approach is labor intensive (e.g., when large numbers of charts are produced daily in an organization). Moreover, the quality of manually generated captions may be inconsistent, and they may vary greatly in length, readability, and insightfulness. Furthermore, a manual approach generally cannot handle time-sensitive use cases, such as business operational dashboards, where the data are queried using a relative time window.

Thus, in some cases, chart captions are automatically generated. However, conventional data visualization and summarization systems are not sufficiently accessible to users who rely on assistive technology. For example, these systems may not be accessible to people who rely on assistive technology such as screen readers or screen magnification, or for people who are not skilled in interpreting charts. This inaccessibility is observed in a variety of web analytics and business intelligent products. For example, business intelligence portals, news articles, and graphical data charts are not fully captured by screen readers. In some cases, only metadata (e.g., the file name of the chart) is available to be read out as audible information. This metadata does not communicate the full meaning of the chart. As a result, screen reader users and users not skilled in chart interpretation are not able to access data insights from the charts.

Furthermore, conventional systems for captioning data are typically tightly coupled with a specific visualization library or a software product. This prevents these systems from being used across multiple applications of websites that do not utilize the specific visualization libraries.

Accordingly, embodiments of the present disclosure include systems and methods for making data visualizations accessible by automatically generating natural language captions. In some cases, the natural language captions describe key insights of a chart. In at least one embodiment, a chart or chart data is categorized by a categorization component, and insight types are selected based on the chart category. In the embodiment, the categorization component determines the chart category based on the types and fields of data included in underlying chart data. For example, if the columns include a time column, the chart can be categorized as a timeseries. If the chart includes a category field and a value field, it may be categorized as a distribution chart.

A list of insight types for each chart category can be stored in memory, and when a category is selected, the insight types can be identified from the list. Then, relevant statistical measures are selected for each insight type, and statistical information is generated for each of the selected statistical measures. For example, the statistical measures can be used to determine average values, extremal values, cyclic patterns, trends, value grouping, anomaly detection, etc.

Then, a caption component combines the statistical information (i.e., the insight data) with a natural language sentence template associated with the insight type to create one or more insight captions. In some embodiments, variable fields in the template are named according to the insight data they are associated with so that the fields can be replaced with relevant words or values.

In some embodiments, insights are ranked and filtered according to insight type specific metrics to yield salient and comprehensible insights. In some embodiments, the framework provides support for multiple chart types and data insight types. The framework is extensible and is designed to be compatible with multiple existing data visualization libraries. In some embodiments, the framework functions based solely on the chart data without referencing the design choices of the chart itself.

In some examples, developers can extend the framework by independently modifying or configuring the constituent components to support additional chart types and insight types for an application. In some examples, a dynamic template approach is used to ensure that dynamic variations in the insight descriptions and provide support for internationalization and content security reviews. In some cases, an implemented system prototype demonstrates application of the framework to increase the accessibility of data visualizations.

By selecting statistical measures based on categories of chart data (as opposed to drawing insights from the visualized chart itself), embodiments of the present disclosure can provide a plug-in solution that is compatible with existing charting libraries and visualization products across multiple applications and websites. These captions can be easily detected by screen readers, and are readily interpreted by users that are not experienced in reading charts.

In the present disclosure, the term “visual element” refers to a portion of a user interface that is designed to convey information to a user using non-verbal images. In some cases, visual elements have both pictorial and verbal elements. Examples of visual elements include images, charts, and graphs.

The term “chart data” refers to data that can be used to generate a visual element such as a chart or graph. For example, chart data may be in the form of a table or a spreadsheet with fields defined by one or more rows and columns. In some cases, each column corresponds to a field header, and rows of the chart data correspond to individual data samples.

The term “chart category” refers to a type of a chart such as timeseries charts (e.g., temporal graphs), distribution charts (e.g., pie charts or bar charts), set relation charts (e.g., Venn diagrams), or network charts. In some cases, multiple chart types can correspond to a same chart category. For example, both pie charts and bar charts can be considered to be in the same category of distribution charts. As used in the present disclosure, the chart category can be determined based solely on the chart data (e.g., based on the column headers or the type of data in the columns) independent of a choice of how to visualize the data.

The term “insight type” refers to a category of insight that corresponds to a particular chart category. Example insight types might include an “extremes” insight type that identifies one or more extreme values in a manner relevant to a particular chart category. Some insight types can be relevant to multiple chart categories, but some may be relevant to a single category. For example, a “trends” insight type might only be relevant for a timeseries chart category.

The term “insight data” refers to data associated with a chart that can used to construct an insight of a particular insight type. For example, insight data for the “extremes” insight type of a distribution chart might include both a highest value and a lowest value of the chart. In some cases, insight data is generated using various statistical techniques applied to the chart data.

The term “statistical measure” refers to the output of a particular statistical technique applied to chart data for the purpose of generating insight data. In some examples, statistical measures are selected based on an insight type in order to generate insight data that can be used to construct an insight caption.

The term “insight caption” refers to a sentence or phrase that describes insight data. In some embodiments, the insight caption refers to a human-understandable natural language sentence or phrase that can be displayed visually or audibly to a user to provide insight about a chart or about chart data.

The term “sentence template” refers to a partially completed sentence or phrase that can be augmented with insight data to generate an insight caption. In some cases, aspects of the sentence template can be dynamic. For example, words of the sentence template can be optional based on the type of data that is available.

The term “one-dimensional distribution clustering algorithm” refers to an algorithm for grouping values based on a single dimension of variation among the values. For example, a one-dimensional distribution clustering algorithm can be used to identify groups of values that can be mentioned together in an insight caption (i.e., a group of highest values, next values, or lowest values).

### Caption Generation

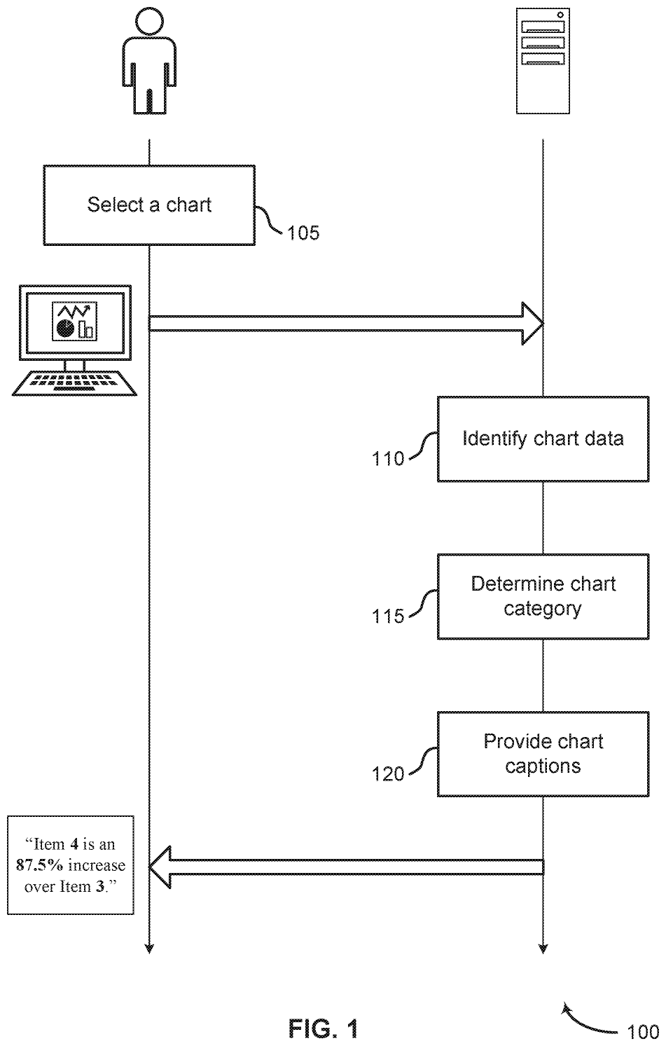

FIG. 1 shows an example of a method 100 for caption generation according to aspects of the present disclosure. The method 100 describes a process by which one or more captions are generated to provide insights for a user regarding a chart. In some examples, these operations are performed by a system including a processor executing a set of codes to control functional elements of an apparatus such as the apparatus described with reference to

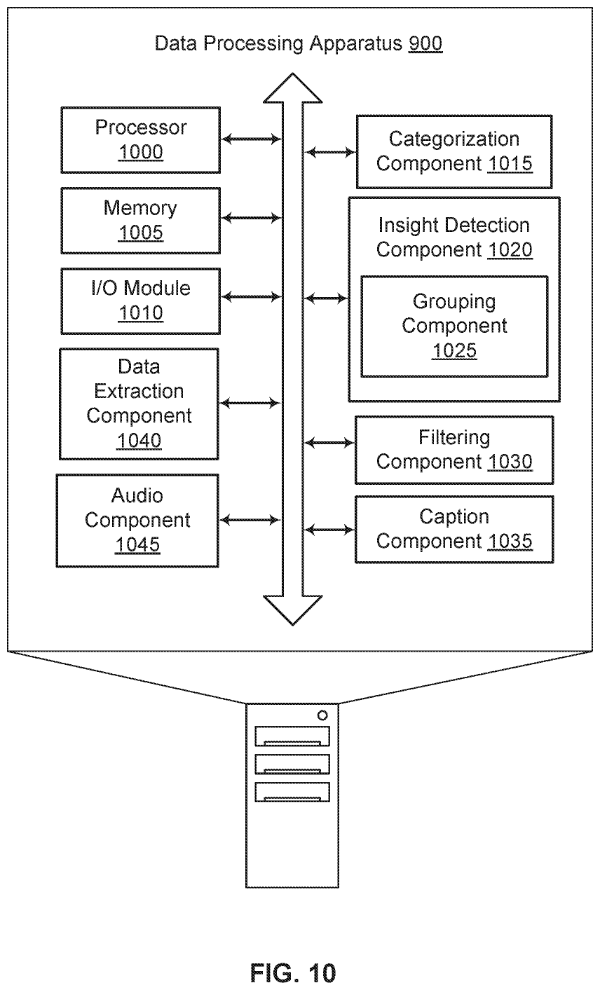

FIG. 10.

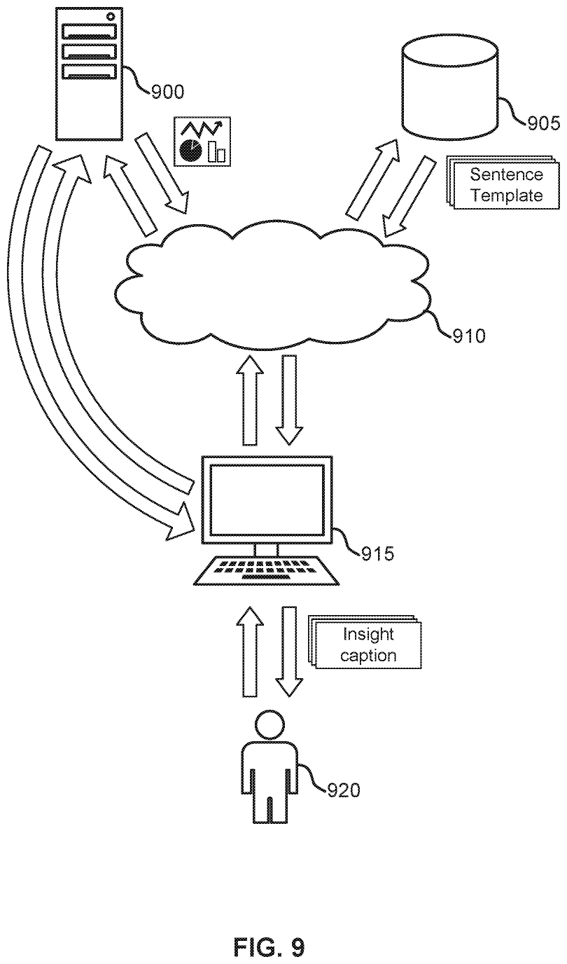

At operation 105, a chart is selected through a user interface. In some cases, the operations of this step refer to, or may be performed by, a user as described with reference to FIG. 9. In some cases, the captions are generated automatically for each chart element on a page rather than waiting for the user to select a chart to be summarized.

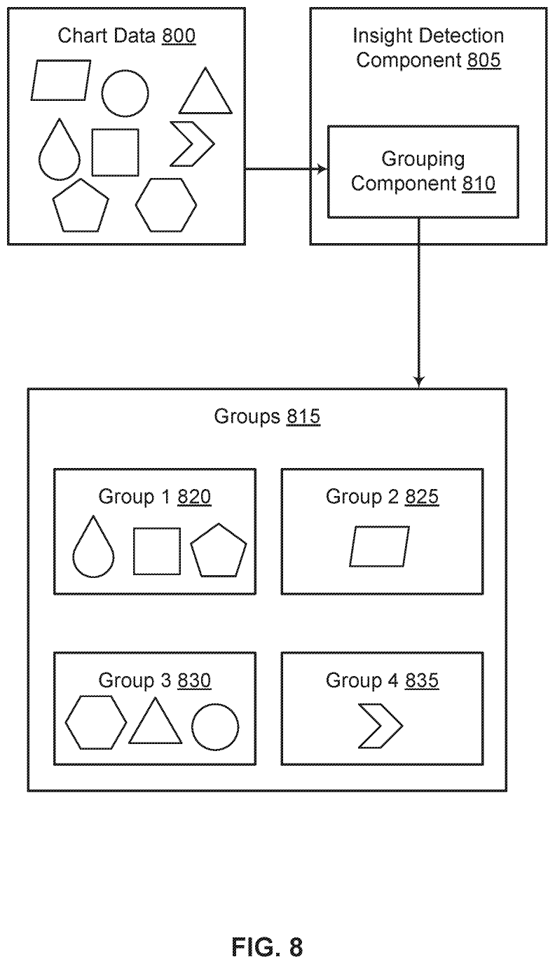

At operation 110, the system identifies chart data. In some cases, the operations of this step refer to, or may be performed by, an insight detection component of a data processing apparatus as described with reference to FIGS. 8 and 10. For example, the system may identify code underlying the visual element, and extract the data from the code. In some examples, a data extraction component of the data processing apparatus extracts the chart data from the code based on a markup language of the code, and the insight detection component identifies information about the chart data.

At operation 115, the system determines a chart category based on the chart data. In some cases, the operations of this step refer to, or may be performed by, a categorization component of the data processing apparatus as described with reference to FIG. 10. For example, the system may determine a chart category based on the data contained in the chart data. Some examples of chart categories include a time-series category, a distribution category, and a set-relation category.

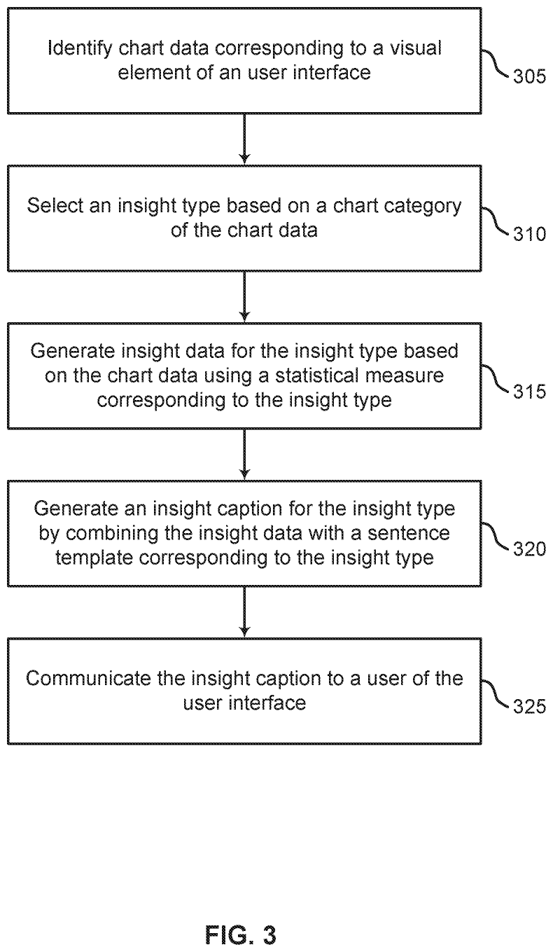

At operation 120, the system provides chart captions for the chart that are more easily readable or interpretable by the user. In some cases, the operations of this step refer to, or may be performed by, a caption component as described with reference to FIG. 10. Further details about the generation of chart captions will be described with reference to FIGS. 3 through 7.

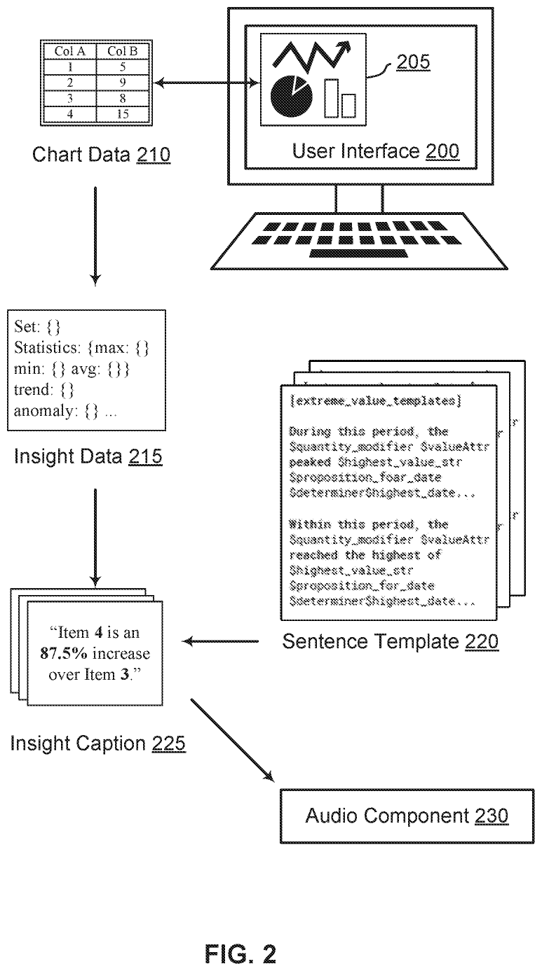

FIG. 2 shows an example of chart processing according to aspects of the present disclosure. The example shown illustrates various components involved in a process of generating captions, and includes user interface 200, visual element 205, chart data 210, insight data 215, sentence template 220, insight caption 225, and audio component 230.

A user interface 200 may enable a user to interact with a device. In some embodiments, the user interface 200 may include an audio device, such as an external speaker system, an external display device such as a display screen, or an input device (e.g., remote control device interfaced with the user interface 200 directly or through an IO controller module). In some cases, a user interface 200 may be a graphical user interface 200 (GUI).

According to some aspects, user interface 200 identifies chart data 210 corresponding to a visual element 205 of a user interface 200. A user may select the visual element 205 by interacting with the user interface 200. In other examples, the system generates captions without a selection from the user. User interface 200 is an example of, or includes aspects of, the corresponding element described with reference to FIG. 9. Generally, the user interface allows the user to interact with the system, and may include several input and output devices.

The chart data 210 may include various data types, and the data may correspond to a chart category. In some embodiments, the chart data is in the form of a table or spreadsheet with multiple columns and rows. For example, a chart data 210 that includes a representation of values changing over time may correspond to a time-series category. Chart data 210 is an example of, or includes aspects of, the corresponding element described with reference to FIG. 8.

Insight data 215 includes information generated from the chart data 210 that is determined to be salient for one or more insights about the chart data 210. This determination, ranking, and filtering is further described with reference to FIGS. 3-8.

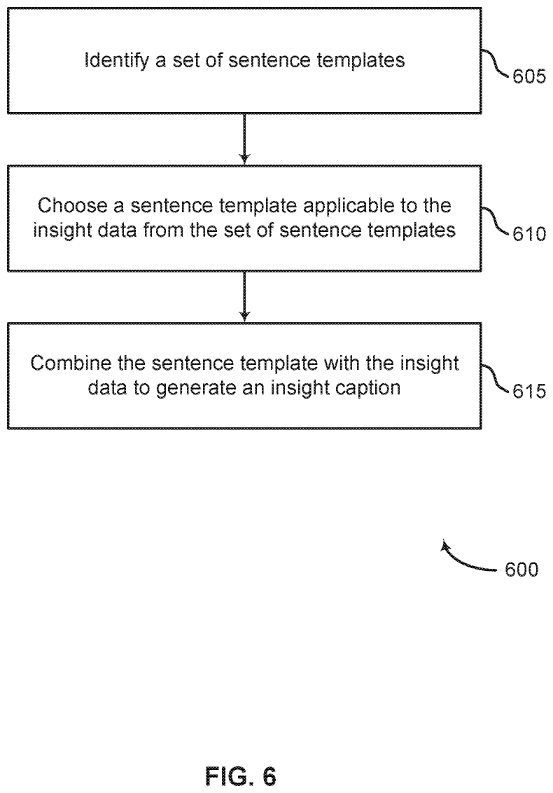

The insight data 215 is then combined with a sentence template 220 to generate insight captions for the chart data 210. In some examples, sentence template 220 contains a natural language sentence or phrase with fields that indicate where insight data can be inserted. In some examples, the sentence template 220 is combined with the insight data 215 to form insight captions 225. Further details about the sentence templates 220 will be described with reference to FIG. 6.

According to some aspects, audio component 230 communicates the insight caption 225 to a user of the user interface 200 using verbal communication. However, in other examples the insights are displayed as text on a screen or otherwise communicated to a user. The audio component 230 may, for example, generate a verbal translation of the insight caption 225 and output it through the user interface 200.

According to some aspects, audio component 230 is configured to generate an audible communication corresponding to the insight caption 225. Audio component 230 is an example of, or includes aspects of, the corresponding element described with reference to FIG. 10.

The components described with reference to FIG. 2, as well as the components described with reference to FIGS. 9 and 10 may implement an extendable, modifiable framework for generating insight captions. In some cases, the input to the framework includes a data table (e.g., chart data 210) that a visualization tool uses for rendering the chart on display. For example, a temporal field with a numerical field for a time-series chart and a nominal field with a numerical field for a bar chart. In some examples, the data table of a chart is small in size and may be included in a payload of data. In some cases, visualization tools perform data query and processing in the backend and exclusively send aggregated data for chart rendering in the frontend. Additionally, the framework accepts two optional parameters (i.e., metadata and config). Metadata specifies the data type of each data field and config specifies locale for translation for end users.

### Data Summarization

According to the embodiments described in FIGS. 3 through 6, various methods for data processing (i.e., data summarization) are described. One or more aspects of the method include identifying chart data corresponding to a visual element of a user interface; selecting an insight type based on a chart category of the chart data; generating insight data for the insight type based on the chart data using a statistical measure corresponding to the insight type; generating an insight caption for the insight type by combining the insight data with a sentence template corresponding to the insight type; and communicating the insight caption to a user of the user interface.

Some examples of the method, apparatus, non-transitory computer readable medium, and system further include identifying code underlying the visual element. Some examples further include extracting the chart data from the code based on a markup language of the code. Some examples of the method, apparatus, non-transitory computer readable medium, and system further include identifying a plurality of chart categories. Some examples further include selecting the chart category from the plurality of chart categories using a rule-based heuristic.

Some examples of the method, apparatus, non-transitory computer readable medium, and system further include determining that the chart data includes a temporal field and a numerical field, wherein the chart category comprises a time-series category. Some examples of the method, apparatus, non-transitory computer readable medium, and system further include determining that the chart data includes a nominal field and a numerical field, wherein the chart category comprises a distribution category. Some examples of the method, apparatus, non-transitory computer readable medium, and system further include determining that the chart data includes a set-relation field and a numerical field, wherein the chart category comprises a set-relation category.

Some examples of the method, apparatus, non-transitory computer readable medium, and system further include identifying a plurality of insight types corresponding to the chart category, wherein the plurality of insight types corresponds to a plurality of statistical measures, respectively. Some examples further include selecting the insight type from the plurality of insight types.

In some aspects, the chart category comprises a time-series category, and the plurality of insight types includes aggregate statistics, cyclic patterns, trends, anomalies, or any combination thereof. In some aspects, the chart category comprises a distribution category, and the plurality of insight types includes aggregate statistics, grouped values, or any combination thereof. In some aspects, the chart category comprises a set-relation category, and the plurality of insight types includes aggregate statistics, grouped values, set comparisons, or any combination thereof.

Some examples of the method, apparatus, non-transitory computer readable medium, and system further include generating a plurality of insights based on the chart category, wherein the insight data corresponds to one of the plurality of insights. Some examples further include ranking the plurality of insights. Some examples further include filtering the plurality of insights based on the ranking, wherein the insight caption is generated based on the filtering. Some examples of the method, apparatus, non-transitory computer readable medium, and system further include identifying a plurality of sentence templates corresponding to a plurality of insight types. Some examples further include selecting the sentence template corresponding to the insight type from the plurality of sentence templates.

FIG. 3 shows an example of a method 300 for data processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 305, the system identifies chart data corresponding to a visual element of a user interface. In some cases, the operations of this step refer to, or may be performed by, a user interface as described with reference to FIGS. 2 and 9. For example, system may identify code underlying the visual element. In some examples, a data extraction component of the data processing apparatus extracts the chart data from the code based on a markup language of the code, and the insight detection component identifies information about the chart data. In some examples, the chart data is provided in a payload from a server or database.

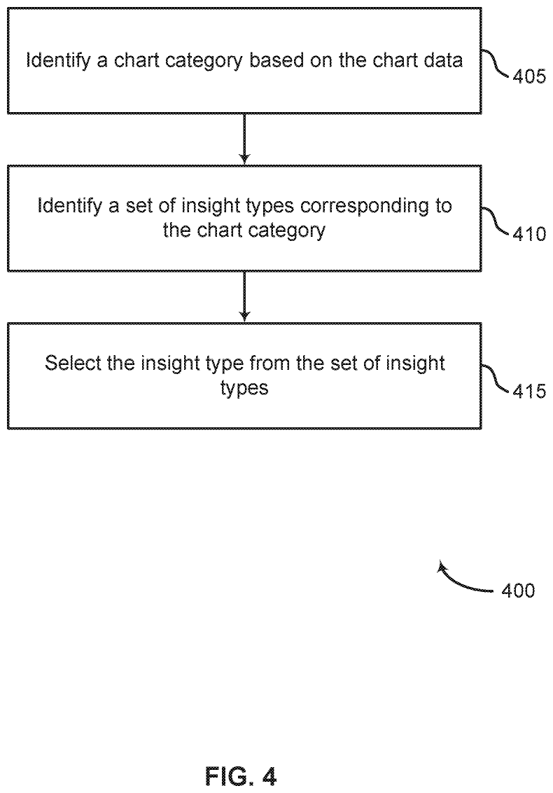

At operation 310, the system selects an insight type based on a chart category of the chart data. In some cases, the operations of this step refer to, or may be performed by, a categorization component as described with reference to FIG. 10. Insight types correspond to types of information that may be notable about the chart data, and include cyclic patterns, trends, anomalies, aggregate statistics, etc. Further detail regarding how the insight types are selected is described with reference to FIG. 4.

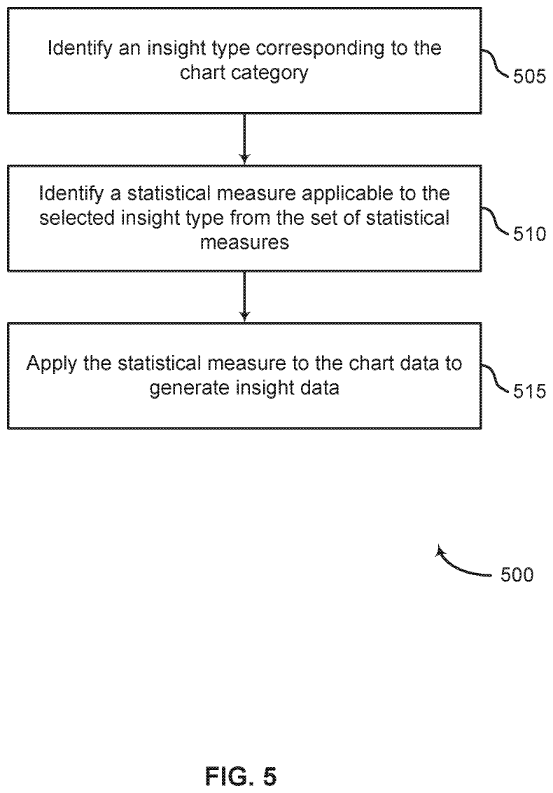

At operation 315, the system generates insight data for the insight type based on the chart data using a statistical measure corresponding to the insight type. In some cases, the operations of this step refer to, or may be performed by, an insight detection component as described with reference to FIGS. 8 and 10. Further detail regarding how the insight data is generated is described with reference to FIG. 5.

At operation 320, the system generates an insight caption for the insight type by combining the insight data with a sentence template corresponding to the insight type. In some cases, the operations of this step refer to, or may be performed by, a caption component as described with reference to FIG. 10. Examples of insight caption may correspond to the insight data 215 of FIG. 2. Further details about the generation of insight captions will be described with reference to FIG. 6.

At operation 325, the system communicates the insight caption to a user of the user interface. In some cases, the operations of this step refer to, or may be performed by, an audio component as described with reference to FIGS. 2 and 10. In some cases, the system communicates the insight caption to the user without the use of the audio component (e.g., by displaying the text on a screen). In some cases, text is displayed on a screen and a separate screen reader verbalizes the text of the insight captions to a user.

FIG. 4 shows an example of a method 400 for selecting an insight type according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 405, the system identifies a chart category based on the chart data. In some cases, the operations of this step refer to, or may be performed by, a categorization component as described with reference to FIG. 10. In some cases, the chart category is determined using a decision tree or rule-based model.

In one example, the system identifies chart categories based on the types of fields in the chart data. For example, the categories include charts with a temporal and numerical field, charts with a nominal and numerical field, and charts with a set-relation and numerical field.

Charts with a temporal field and a numerical field are used for showing the change of a metric over a period of time (e.g., revenue by datetime in a line-chart, area-chart, bar-chart, etc.). For example, viewers are interested in insights that can reveal timeseries patterns such as peaks and valleys, overall trends, seasonality, sharp changes, etc. Charts with these fields may be identified as belonging to a time-series category.

An example of a timeseries chart could be daily revenue in the last week from an analytics platform or daily added profiles in the last 30 days in customer experience management platform. In some examples, an area-chart or a bar-chart can be used for showing the total data volume or the discrete data points.

For example, a timeseries chart with a temporal field and a numerical field and the corresponding insight captions can be generated by the system. Insights about maximum value, minimum value, and anomalies are detected and annotated in the caption using chart data.

Charts with a nominal field and a numerical field are used for seeing the distribution of a metric broken down by a dimension (e.g., total visitors by country in a bar-chart, donut-chart, line-chart, etc.). For example, viewers may be interested in insights that can describe the shape of the data distribution, such as extreme values, skewness, variations, and comparisons. Charts with these fields may be identified as belonging to a distribution category.

Charts with a set-relation field and a numerical field are designed for showing set relationships among groups (e.g., overlaps of different audience segments in a Venn diagram or a two-step Sankey diagram). The set-relation field contains nominal values, including the original values (e.g., group A, group B, group C, etc.) and combination values (e.g., group A and B, group B and C, group A and B and C, etc.). Viewers are interested in learning about the differences and similarities among the groups, especially independent pairs (i.e., zero overlaps) and correlated pairs (i.e., significant overlaps or inclusion). Charts with these fields may be identified as belonging to a set-relation category.

At operation 410, the system identifies a set of insight types corresponding to the chart category. In some cases, the operations of this step refer to, or may be performed by, an insight detection component as described with reference to FIGS. 8 and 10. Insight types correspond to types of information that may be notable about the chart data, and include cyclic patterns, trends, anomalies, aggregate statistics, etc.

At operation 415, the system selects the insight type from the set of insight types. In some cases, the operations of this step refer to, or may be performed by, an insight detection component as described with reference to FIGS. 8 and 10. This process may be repeated to select more than one insight type.

FIG. 5 shows an example of a method 500 for generating insight data according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 505, the system identifies an insight type corresponding to the chart category. In some examples, different chart categories have different insight types (e.g., a timeseries chart might have a “trends” insight, whereas both a timeseries chart and a distribution chart might have an “extreme values” insight type.

At operation 510, the system identifies a statistical measure applicable to the selected insight type from the set of statistical measures. In some cases, the operations of this step refer to, or may be performed by, an insight detection component as described with reference to FIGS. 8 and 10. Statistical measures may include any number of statistical analyses that are capable of being performed on the data, such as determining mean, median, mode, central tendencies, various algorithms to group or sort the data, etc.

At operation 515, the system applies the statistical measure to the chart data to generate insight data. In some cases, the operations of this step refer to, or may be performed by, an insight detection component as described with reference to FIGS. 8 and 10.

Aggregate statistics are one of many insight types. Aggregate statistics include statistical data facts which enable grasping of the overall shape of the data at a high speed by users. These may include the maximum, minimum, and average data points for timeseries data. For example, for a bar chart, readers are interested in the overall statistics on the bar chart including skewness and variability. For example, large valued skewed bars can be identified and described if the values exceed 1.5×IQR (i.e., Inter Quarter Range).

An example embodiment of the disclosure includes a timeseries chart to show the trend of product orders during holiday season. In some examples, the data processing apparatus 900 produces captions that describe overall statistics using chart and data obtained from an analytics platform as:

“The number of orders reached the highest
of 1,510,256 on Nov. 27th, 2020. It was 481%
more than the average of 259,791. The lowest
number of orders occurred on Oct. 10th, 2020
at 105,022, which was 60% less than the average.”

Cyclic patterns are another insight type. Cyclic patterns exist in temporal data from diverse sources, including vital signals from medical devices and atmospheric measures from weather sensors. For example, the salient cyclic patterns in operational KPIs and campaign performances in business and digital marketing are known. The algorithm identifies potential cyclic patterns from a timeseries data using a temporal correlation method. In some cases, the temporal correlation method calculates the correlation coefficient between the timeseries and a corresponding delayed copy with different time windows. A cyclic pattern is considered salient and reported in the caption if the coefficient is more than a threshold. In some examples, the time windows used for timeseries data are of different granularity.

An example process for detecting cyclic patterns is delineated in the following algorithm:

Algorithm: Detect Cyclic Patterns

```
Input: timeseries (list of date-value pairs), granularity (e.g., hour, day, week), threshold
(minimum coefficient value required for showing up in caption)
Procedure:
  for time_window in time_windows[granularity]:
    timeseries_copy = shift_time(timeseries, time_window)
    coefficient = temporal-correlation(timeseries, timeseries_copy)
      if coefficient > threshold:
        return time_window
  return None
```

An embodiment of the disclosure includes a timeseries chart including a cyclic pattern. Other insight types include trends and anomalies. For example, a timeseries data collected from real-world applications or sensors can be decomposed into three components: yₜ=Sₜ+Tₜ+Iₜ, where yₜ is the original data, Sₜ is the seasonal component, Tₜ is the trend component, and Iₜ is the irregular component. An algorithm executed by the insight detection component 1020 may use a timeseries decomposition approach to extract the Tₜ (trend) and Iₜ (irregular, i.e., the anomalous spikes in the data).

An example process for detecting trends is delineated in the following algorithm:

Algorithm: Longest Continuous Trend Detection

```
Input: timeseries (list of date-value pairs), minimum_trend_length (for ignoring trends that
are too short),
  maximum_trend_delta (if the value difference between two steps exceeds this threshold,
consider it not continuous)
Procedure:
    components = timeseries-decompose(timeseries, model=‘additive’)
    trend_line = components.trend
    longest_trend = max(continuous-periods(trend_line, maximum_trend_delta))
    if len(longest_trend) > minimum_trend_length:
      return longest_trend
    else:
      return None
```

An example process for detecting spikes is delineated in the following algorithm:

Algorithm: Spikes Detection

```
Input: timeseries (list of date-value pairs), minimum_anomaly_delta (only keep large spikes)
Procedure:
  components = timeseries-decompose(timeseries, model=‘additive’)
  spikes = components.irregular
  for i in range(len(spikes)):
      if spike[i] − average(timeseries) > minimum_anomaly_delta:
        continue
      else:
    spike[i] = None
  return [s for s in spikes if s is not None]
```

An example embodiment of the disclosure includes output of the extracted trend and spike components. In some examples, a timeseries decomposition model is applied to an original timeseries data to obtain a trend and spike component.

In some cases, the detected continuous trend with maximum length and the anomalous spikes are described in languages. For example, the detected trends and spikes may be described in natural language insight captions.

FIG. 6 shows an example of a method 600 for generating an insight caption according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 605, the system identifies a set of sentence templates. In some cases, the operations of this step refer to, or may be performed by, a caption component as described with reference to FIG. 10. One or more examples of the sentence templates may correspond to the example sentence template 220 illustrated in FIG. 2.

The use of sentence templates is one way for the system to incorporate insight data into natural language captions. For example, in a template-based approach, text templates are prepared for each insight type with placeholders for dynamic information such as dates, numbers, and attribute names. The template-based approach is appropriate for a production environment as the approach ensures a high quality and security of the languages.

In some cases, the quality and security of the templates is controlled through a process of preparation, translation, and review. In some examples, the templates are prepared by professional copywriters, translated into non-English languages for globalization, and reviewed by legal and content approvers. Furthermore, multiple styles of templates are designed with different degrees of conciseness and formality to mitigate the limitation of showing users the same text every time. In some cases, the degree of conciseness and formality can be selected according to the user role and preferences, e.g., executive roles may prefer concise languages while analyst roles may prefer more details. Each template style includes multiple variations that are phrased differently to show varied languages to users while browsing different charts and dashboards.

At operation 610, the system chooses a sentence template applicable to the insight data from the set of sentence templates. In some cases, the operations of this step refer to, or may be performed by, a caption component as described with reference to FIG. 10.

At operation 615, the system combines the sentence template with the insight data to generate an insight caption. In some cases, the operations of this step refer to, or may be performed by, a caption component as described with reference to FIG. 10.

For example, the chart and data obtained from an analytics platform can be used to produce example captions such as:

| | |
|---|---|
| • | “Overall, there was a cyclic pattern that repeated every 24 hours. For each day, the |
| | peak number of visits occurred at around 14:38 and the valley occurred at around |
| | 18:32.” |
| • | “At a high-level, there was a statistically significant cyclic pattern for every week |
| | window. For each week, the peak number of purchases occurred at around the 2nd |
| | day and the valley occurred at around the 3rd day.” |
| • | “Overall, there was a notable cyclic pattern at every interval of quarter. For each |
| | interval, the peak number of sales occurred on average in the 1st month and the |
| | valley occurred at around the 2nd month.” |
| • | “At a high-level, there was a statistically significant cyclic pattern for every year |
| | window. For each year, the peak number of sales occurred at around the 1st quarter |
| | and the valley occurred at around the 3rd quarter.” |

The following are examples of insight captions corresponding to a timeseries chart:

| | |
|---|---|
| • | The number of orders reached the highest of 1,510,256 on Nov. 27th, 2020. It was |
| | 481% more than the average of 259,791. |
| • | The lowest number of orders occurred on Oct. 10th, 2020 at 105,022, which was |
| | 60% less than the average.” |

Some example insight captions that describe trends include:

| | |
|---|---|
| • | Throughout this period, there was a downward trend from Oct. 13th, 2020 to Oct. |
| | 29th, 2020 at a rate of −36,798 less visits per time-step, going down from 11,974,677 |
| | to 11,385,900. |
| • | 2 anomalous number of visits were detected on Oct. 13th, 2020 and Oct. 29th, 2020. |
| | On average, the number of visits on these dates deviated by 67% from expectation. |

Some example insight captions that relating to the aggregate statistics insight type include:

| | |
|---|---|
| • | For One Month Return, the return value is highly skewed towards total Consumer |
| | Goods. |
| • | For YTD Return, the return value is highly skewed towards total K. |

Some example insight captions relating to a distribution category are provided below:

| | |
|---|---|
| • | Identities crmid, loyal and ecid have the highest numbers of profiles, which are 21,888, |
| | 22,268 and 28,307, respectively. Next is identity email, which has 13,723 profiles. |
| | Identity aaid contains the lowest number of profiles, which is 2,333. |
| • | United States and Europe have the highest numbers of profiles, which are 3,400 and |
| | 5,000, respectively. Next is Canada with 1,722 profiles. Mexico has the lowest number |
| | of profiles, which is 500. |

In some cases, templates may be generated for multiple languages. For example, the following are template variations that may be used to describe the maximum-value insight and the corresponding non-English (i.e., French) translations.

“maximum_value_templates_en-US”: [
“During this period, the amount of {attribute_friendly_name} peaked {highest_value_str} on
{highest_date}. The highest amount of {attribute_friendly_name} was {percentage_more}
more than the average.”,
“Within this period, the amount of {attribute_friendly_name} reached the highest of
{highest_value_str} on {highest_date}. It was {percentage_more} more than the average.”,
“Throughout this period, the amount of {attribute_friendly_name} topped
{highest_value_str} on {highest_date}. It was {percentage_more} more than the average.”
]
“maximum_value_templates_fr-FR”: [
“Pendant cette période, la quantité de {attribute_friendly_name} a atteint un sommet
{highest_value_str} sur {highest_date}. Le montant le plus élevé de
{attribute_friendly_name} était {percentage_more} supérieur à la moyenne.”,
“Au cours de cette période, le montant de {attribute_friendly_name} a atteint le plus élevé de
{highest_value_str} sur {highest_date}. C'était {percentage_more} plus que la moyenne.”,
“Pendant toute cette période, le montant de {attribute_friendly_name} a dépassé
{highest_value_str} sur {highest_date}. C'était {percentage_more} plus que la moyenne.”
]

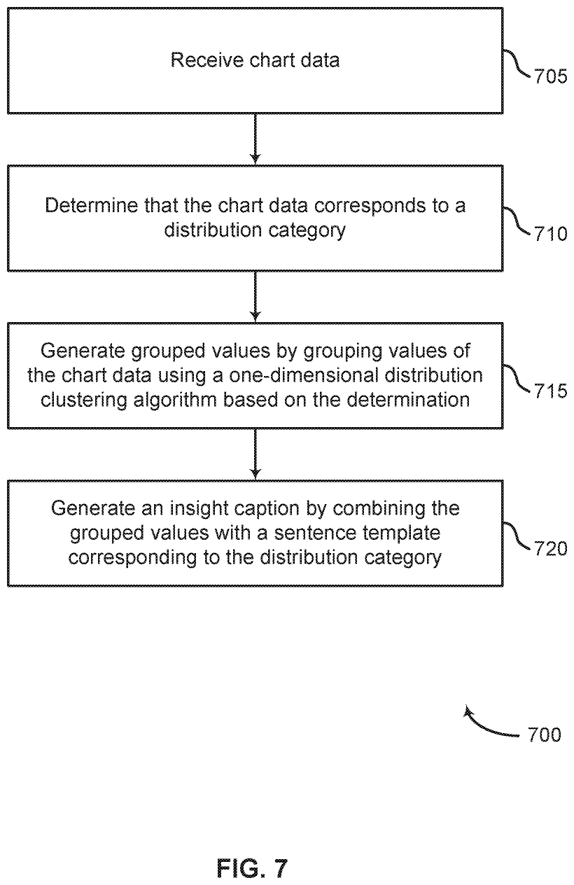

In FIG. 7, another method for data processing is described. One or more aspects of the method include receiving chart data; determining that the chart data corresponds to a distribution category; generating grouped values by grouping values of the chart data using a one-dimensional distribution clustering algorithm based on the determination; and generating an insight caption by combining the grouped values with a sentence template corresponding to the distribution category.

Some examples of the method, apparatus, non-transitory computer readable medium, and system further include determining that the chart data includes a nominal field and a numerical field, wherein the determination that the chart data corresponds to the distribution category is based on the nominal field and the numerical field. In some aspects, the one-dimensional distribution clustering algorithm satisfies a complete-linkage criterion.

Some examples of the method, apparatus, non-transitory computer readable medium, and system further include sorting a plurality of values of the chart data. Some examples further include selecting a group for each of the plurality of values based on a minimum distance between a current value and values in a current group.

FIG. 7 shows an example of a method 700 for data processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 705, the system receives chart data. In some cases, the operations of this step refer to, or may be performed by, a user interface as described with reference to FIGS. 2 and 9. The system may receive chart data from a database, for example. In another example, the system may retrieve chart data from a memory within the system.

At operation 710, the system determines that the chart data corresponds to a distribution category. In some cases, the operations of this step refer to, or may be performed by, a categorization component as described with reference to FIG. 10.

At operation 715, the system generates grouped values by grouping values of the chart data using a one-dimensional distribution clustering algorithm based on the determination. In some cases, the operations of this step refer to, or may be performed by, a grouping component as described with reference to FIGS. 8 and 10.

The one-dimensional distribution clustering algorithm groups values by the similarities between values, and ensures every value is assigned to some group. For example, the maximum value and minimum value within a group or sentence are similar for each group or sentence. The objective can be described as clustering one-dimensional distribution with complete-linkage criterion. In some cases, the algorithm divides the values into different groups satisfying the complete linkage criterion.

At operation 720, the system generates an insight caption by combining the grouped values with a sentence template corresponding to the distribution category. In some cases, the operations of this step refer to, or may be performed by, a caption component as described with reference to FIG. 10. For example, insight captions may include multiple paragraphs or sentences, with each paragraph or sentence corresponding to a group, and containing insight data about that group.

For example, the bars in a distribution category chart may contain meaningful narratives. These meaningful narratives can be grouped in separate sentences, such as insight captions, based on the ranges of values.

FIG. 8 shows an example of generating grouped values according to aspects of the present disclosure. The example shown includes chart data 800, insight detection component 805, and groups 815. The insight detection component 805 may be similar to the insight detection component 1020 of the data processing apparatus 900, and may be implemented by a general processor.

A processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, the processor is configured to operate a memory array using a memory controller. In other cases, a memory controller is integrated into the processor. In some cases, the processor is configured to execute computer-readable instructions stored in a memory to perform various functions. In some embodiments, a processor includes special purpose components for modem processing, baseband processing, digital signal processing, or transmission processing.

Chart data 800 is an example of, or includes aspects of, the corresponding element described with reference to FIG. 2. For example, when the chart data includes nominal and numerical fields, the nominal fields may be represented by the shapes illustrated in FIG. 8.

According to some aspects, insight detection component 805 generates insight data for the insight type based on the chart data 800 using a statistical measure corresponding to the insight type. In some examples, insight detection component 805 identifies a set of insight types corresponding to the chart category, where the set of insight types corresponds to a set of statistical measures, respectively. In some examples, insight detection component 805 selects the insight type from the set of insight types. In some examples, insight detection component 805 generates a set of insights based on the chart category, where the insight data corresponds to one of the set of insights.

According to some aspects, insight detection component 805 is configured to generate insight data for an insight type based on the chart data 800 and the chart category using a statistical measure corresponding to the insight type. In some aspects, the insight detection component 805 is further configured to perform a one-dimensional distribution clustering algorithm.

Insight detection component 805 is an example of, or includes aspects of, the corresponding element described with reference to FIG. 10.

In one aspect, insight detection component 805 includes grouping component 810. According to some aspects, grouping component 810 generates grouped values by grouping values of the chart data 800 using a one-dimensional distribution clustering algorithm based on a determination that the chart data corresponds to a “distribution” chart category. For example, chart data may correspond to a distribution category when the chart data contains a nominal field and a numerical field. The information in the chart data may divided into different paragraphs, such as insight captions, for describing data and comparison in the charts (e.g., bar charts).

In at least one embodiment, the one-dimensional distribution clustering algorithm groups values that are similar in magnitude. In some aspects, the one-dimensional distribution clustering algorithm satisfies a complete-linkage criterion; e.g., every input value is contained within one group in the set of output groups. In some examples, grouping component 810 sorts a set of values of the chart data 800. In some examples, grouping component 810 selects a group for each of the set of values based on a minimum distance between a current value and values in a current group.

An example one-dimensional distribution clustering algorithm is proved below:

Algorithm Group_Distribution

Input: input_distribution (list of chart values), threshold (maximum allowed difference
between minimum and maximum values in each group)
Output: grouped_indices (list of grouped indices)

| | |
|---|---|
| 1. | sorted_values, sorted_indices = sort(input_distribution, return_index=True) |
| | (Given a list of bars, we first sort them based on their values (in ascending order).) |
| 2. | grouped_indices, current_group = [ ], [ ] |
| | (We initialize a list to store the groups and a temporarily list to group the values |
| | throughout the iteration on the list of sorted values.) |
| 3. | for value in sorted_values: |
| | if size(current_group) == 0 or min(current_group) * threshold < value: |
| | current_group.push(value) |
| | else: |
| | grouped_indices.push(current_group) |
| | current_group = [ ] |
| | current_group.push(value) |
| | grouped_indices.push(current_group) |
| | (During the iteration, if the value is greater than the smallest value in current_group |
| | with a great extent. Then, the list of current_group will be pushed to grouped_indices |
| | and current_group will be initialized.) |

The same operations are performed within each group or stack for bar charts with grouped values (e.g., grouped, or stacked bar charts). In some examples, the algorithm groups the value in each x-axis attribute followed by presenting the values individually in each paragraph.

Some examples of insights generated by insight data from the grouping component 810 based on time period groups include:

| | |
|---|---|
| • | For One Week Return, total Consumer Goods and total K have 1.84% and 2.32% in |
| | return. |
| • | For One Month Return, total Consumer Goods has the highest value of 3.82% in |
| | return. Total K has the lowest value, with 0.5% in return. |
| • | For YTD Return, total K has the highest value of 15.5% in return. Total Consumer |
| | Goods has the lowest value, with 2.75% in return. |
| • | For 12 Month Return, total K has the highest value, with 21.5% in return. Total |
| | Consumer Goods has the lowest value, with 13.4% in return. |

The comparison of sets with the same degree is described for charts displaying numerical values and with attributes sharing values like a Venn diagram. A degree of an intersection refers to the number of sets occurred in the intersection. The algorithm (i.e., Group_Distribution) is executed in each set of same-degree sets followed by presenting the sets individually in each paragraph.

Some example insight captions generated from distribution category same-degree chart data include:

| | |
|---|---|
| • | Among all identities, crmid has the highest value of 21,888 profiles. email has the |
| | lowest value of 13,723 profiles. |
| • | The most prominent overlap between any two identities is crmid and email, which has |
| | 647 profiles in common. |

Grouping component 810 is an example of, or includes aspects of, the corresponding element described with reference to FIG. 10. The grouping component 810 may receive the chart data 800, and generate groups 815. For example, the grouping component may execute the one-dimensional distribution clustering algorithm on the chart data 800, and form groups 815. In one aspect, groups 815 includes group 1 820, group 2 825, group 3 830, and group 4 835.

Insight captions may be generated by combining the grouped values with a sentence template corresponding to the distribution category. In FIG. 8, groups 1, 2, and 4 may be represented in an example caption, and the example insight caption may be of the form:

| | |
|---|---|
| • | Identities drop, square, and pentagon have the highest values, which are drop |
| | value, square value, and pentagon value, respectively. Next is parallelogram, |
| | which has parallelogram value. Identity chevron contains the lowest value, which |
| | is chevron value. |

The identities and placeholder values used in the above example would be replaced by the real nominal category and their respective values (e.g., number of profiles, sales, ratings, etc.).

### System Architecture

In FIGS. 9 and 10, a system and apparatus for data processing are described. One or more aspects of the apparatus include a categorization component configured to select a chart category from a plurality of chart categories based on chart data using a rule-based heuristic; an insight detection component configured to generate insight data for an insight type based on the chart data and the chart category using a statistical measure corresponding to the insight type; a filtering component configured to filter a plurality of insights based on a ranking of the plurality of insights; and a caption component configured to generate an insight caption for the insight type based on the insight data and the filtering.

Some examples of the apparatus, system, and method further include a data extraction component configured to extract the chart data from code of a visual element of a display based on a markup language of the code. Some examples of the apparatus, system, and method further include an audio component configured to generate an audible communication corresponding to the insight caption. In some aspects, the insight detection component is further configured to perform a one-dimensional distribution clustering algorithm.

FIG. 9 shows an example of a data processing system according to aspects of the present disclosure. The example shown includes data processing apparatus 900, database 905, cloud 910, user interface 915, and user 920.

User interface 915 is an example of, or includes aspects of, the corresponding element described with reference to FIG. 2. In some cases the user interface includes visual elements that are generated by a website browser, or another visualization engine based on code such as HTML or JavaScript.

A cloud is a computer network configured to provide on-demand availability of computer system resources, such as data storage and computing power. In some examples, the cloud provides resources without active management by the user. The term cloud is sometimes used to describe data centers available to many users over the Internet. Some large cloud networks have functions distributed over multiple locations from central servers. A server is designated an edge server if it has a direct or close connection to a user. In some cases, a cloud is limited to a single organization. In other examples, the cloud is available to many organizations. In one example, a cloud includes a multi-layer communications network comprising multiple edge routers and core routers. In another example, a cloud is based on a local collection of switches in a single physical location.

A database is an organized collection of data. For example, a database stores data in a specified format known as a schema. A database may be structured as a single database, a distributed database, multiple distributed databases, or an emergency backup database. In some cases, a database controller may manage data storage and processing in a database. In some cases, a user interacts with database controller. In other cases, database controller may operate automatically without user interaction.

For example, the cloud 910 may interconnect the data processing apparatus 900, the database 905, and the user 920 as the user 920 interacts with the user interface 915. In some embodiments, the user interface 915 directly interacts with the data processing apparatus 900 without a cloud 910 layer therebetween. For example, the data processing apparatus 900 may be localized to a user device or personal computer. In other embodiments, the data processing apparatus 900 is implemented as a server that accessed through the cloud 910 layer.

In an example use case, a user 920 may select a chart using the user interface 915. The data processing apparatus 900 may provide the chart, and any associated metadata or config data, directly to the user interface 915 or to the user interface 915 through the cloud 910. To generate captions, the data processing apparatus 900 may execute the processes described above, and may retrieve other data such as sentence templates from the database 905. Finally, the data processing apparatus 900 may provide the insight caption to the user interface 915 directly, or through the cloud 910.

Embodiments of the present disclosure may be constructed as a stand-alone system or in conjunction with other systems. In one embodiment, a low verbosity graph is generated that contains a limited amount of onscreen information. In this example, a graph tooltip (i.e., an information box that displays when a point is hovered over) only shows surface level information about the plotted points. Further information may be stored in an “accessibility notes” feature of a library and may include customized information about the chart's structure, purpose, context, statistical notes, and more.

In another embodiment, a high verbosity graph contains the most onscreen information, primarily in the chart's tooltips. The tooltips for each data point surfaced information including the value of the data point, its distance from the next and previous data points, and information about which points were the minimum and maximum points in the series. Additionally, this graph included a button marked “View Takeaways”, which triggered a dialog showing the graph next to bulleted sentences detailing the most important features of the visualization. Our solution's experience provided the same information to all users (screen reader or no screen reader).

FIG. 10 shows an example of a data processing apparatus according to aspects of the present disclosure. The example shown includes data processing apparatus 900, processor 1000, memory 1005, I/O module 1010, categorization component 1015, insight detection component 1020, filtering component 1030, caption component 1035, data extraction component 1040, and audio component 1045.

According to some aspects, categorization component 1015 selects an insight type based on a chart category of the chart data. In some examples, categorization component 1015 identifies a set of chart categories. In some examples, categorization component 1015 selects the chart category from the set of chart categories using a rule-based heuristic.

In some examples, categorization component 1015 determines that the chart data includes a temporal field and a numerical field, where the chart category includes a time-series category. In some examples, categorization component 1015 determines that the chart data includes a nominal field and a numerical field, where the chart category includes a distribution category. In some examples, categorization component 1015 determines that the chart data includes a set-relation field and a numerical field, where the chart category includes a set-relation category.

In some aspects, the chart category includes a time-series category, and the set of insight types includes aggregate statistics, cyclic patterns, trends, anomalies, or any combination thereof. In some aspects, the chart category includes a distribution category, and the set of insight types includes aggregate statistics, grouped values, or any combination thereof. In some aspects, the chart category includes a set-relation category, and the set of insight types includes aggregate statistics, grouped values, set comparisons, or any combination thereof.

Insight detection component 1020 is an example of, or includes aspects of, the corresponding element described with reference to FIG. 8. As described above, the insight detection component 1020 may identify an insight type to be generated. Insight types correspond to types of information that may be notable about the chart data, and include cyclic patterns, trends, anomalies, aggregate statistics, etc.

In some cases, the insight detection component 1020 uses the chart data and the identified chart category to generate an unordered list of insights. For example, chart captions written by expert analysts for each chart category are surveyed to determine insights that may be interesting to chart viewers.

In one aspect, insight detection component 1020 includes grouping component 1025. Grouping component 1025 is an example of, or includes aspects of, the corresponding element described with reference to FIG. 8. For further detail on the grouping component 1025, refer to the corresponding element and description with reference to FIG. 8.

According to some aspects, filtering component 1030 ranks the set of insights. In some examples, filtering component 1030 filters the set of insights based on the ranking, where the insight caption is generated based on the filtering.

In some cases, a total number of detected insights can be high when the data is complex or multiple insight detection algorithms are used. A hierarchical filtering and ranking approach is designed that can prioritize insights. The filtering and ranking approach filters insights of each type (i.e., extremes, trends, seasonality, anomalies, etc.) by the associated statistical significance. The insight types are ranked based on the number of significant insights included. Specifically, insights of each type are filtered by a significance score produced by a detection algorithm (e.g., one or more algorithms executed by the insight detection component 1020).

In one embodiment, a temporal correlation algorithm executed by the insight detection component 1020 gives a coefficient score indicating the strength of an observed cyclic pattern. A minimum coefficient and the coefficient score may be used for filtering by the filtering component 1030.

Trends can refer to a period of continuous growth or decline. Each detected trend is associated with a duration. A minimum length of duration may be used for filtering by the filtering component 1030. Anomalies are spikes in the data that deviate from the normal value range. A minimum percentage difference between an anomalous value and the overall average value may be used for filtering by the filtering component 1030. A minimum percentage difference between the pair of values being compared is used for filtering.

An algorithm executed by the insight detection component 1020 produces a coefficient score that indicates the significance of the lean of a distribution towards one side (i.e., away from the mean). The filtering component 1030 may use a minimum skewness coefficient in conjunction with the coefficient score for filtering.

The above example approach ensures a fair ranking among homogeneous insights of the same type and heterogeneous insights of different types. In some examples, users see the top N most significant insights of the top K most prominent insight types in the results, where both N and K are configurable. In some cases, users can pin certain types of insights that are used for the analyses. As a result, the types of insights are top-ranked.

According to some aspects, caption component 1035 generates an insight caption for the insight type by combining the insight data with a sentence template corresponding to the insight type. In some examples, caption component 1035 identifies a set of sentence templates corresponding to a set of insight types. In some examples, caption component 1035 selects the sentence template corresponding to the insight type from the set of sentence templates.

According to some aspects, caption component 1035 generates an insight caption by combining the grouped values with a sentence template corresponding to the distribution category. According to some aspects, caption component 1035 is configured to generate an insight caption for the insight type based on the insight data and the filtering.

In some cases, the caption component 1035 may further generate a context description. For example, the caption component 1035 may generate a context description based on chart data, and may do so based on metadata contained in or associated with the chart data.

For example, a context description may be in the form of the following:

| | |
|---|---|
| • | “This is a timeseries chart that shows the trend of the number of visitors during the |
| | period of February 2018 to September 2019.” |
| • | “This chart shows the distribution of the number of profiles broken down by 4 |
| | countries.” |
| • | “This chart shows the overlapping relationship between profiles with identity crm- |
| | id and profiles with identity email-id.” |

This context description may be generated by the caption component 1035, or may be generated by a separate component of the data processing apparatus 900 such as a context description component.

According to some aspects, data extraction component 1040 identifies code underlying the visual element. In some examples, data extraction component 1040 extracts the chart data from the code based on a markup language of the code. According to some aspects, data extraction component 1040 is configured to extract the chart data from code of a visual element of a display based on a markup language of the code.

Audio component 1045 is an example of, or includes aspects of, the corresponding element described with reference to FIG. 2. The audio component 230 may, for example, generate a verbal translation of the insight caption 225 and output it through the user interface 200. In some cases, the audio component 230 is not used to communicate the captions to the user.

Embodiments of the elements described in FIG. 10 may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the components and their functions described herein may be implemented in hardware or software and may be executed by a processor, firmware, or any combination thereof. If implemented in software executed by a processor, the functions may be stored in the form of instructions or code on a computer-readable medium.

Embodiments of the present disclosure include a stand-alone system prototype configured to enhance data visualization experience of users with accessibility needs. However, blind and visually impaired screen reader users are not able to see data visualization patterns in the same way as sighted people. Therefore, there is a need in the art to understand the amount of information (i.e., presented audibly) which is appropriate to provide a comprehensive understanding of the visualizations.

An example embodiment of the disclosure includes user research trials configured to provide an overview of the accessibility needs and data visualization experience of the participants. For example, the trial may be conducted with 8 participants. The results show evidence that the data insight description provided is useful for low vision users who rely on magnification software and/or screen readers. Additionally, the solution provided is comprehensible.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

Embodiments of the present disclosure include an algorithmic framework configured to detect key data insights and generate natural language captions. In some cases, the framework uses an underlying data table of a visualization to generate natural language captions for communicating the insights with end users. The framework models the captioning task as four interconnected computation modules, i.e., chart categorization, data insight detection, insight filtering and ranking, and language templating.

In some cases, the framework enables acceleration of the development process while serving multiple applications. Additionally, the framework reduces network and computation bottlenecks. For example, the development process can be accelerated by independent agile updating of each module of the framework. In some examples, the modules are updated for adding new capabilities, such as supporting new chart types and insight types, or adding new rules for filtering and ranking. Similarly, developers can adapt a baseline version of the framework to support new business domains. For example, insight ranking and language templating modules can be varied to incorporate domain rules and terminologies (i.e., while the rest of the framework can be reused) to build a captioning service for a new domain application (e.g., from marketing to financial). In some cases, bottlenecks may occur in certain modules and slow down the captioning service due to the size of input data or the complexity of algorithms an application uses (e.g., advanced models for insight detection or insight ranking). Embodiments of the present disclosure include a framework configured to decompose the captioning service into four interconnected modules. In some cases, the decomposition enables developers to allocate additional network or computation resources to the modules with bottlenecks. As a result, the overall responsiveness of the captioning service is ensured.

What is claimed is:

1. A method for data processing, comprising:
identifying, by a data extraction component, chart data corresponding to a visual element of a user interface;
selecting, by an insight detection component, an insight type based on a chart category of the chart data;
generating, by the insight detection component, insight data for the insight type based on the chart data using a statistical measure corresponding to the insight type;
generating, by a caption component, an insight caption for the insight type by combining the insight data with a sentence template corresponding to the insight type; and
communicating, via the user interface, the insight caption to a user of the user interface.

2. The method of claim 1, further comprising:
identifying, by the data extraction component, code underlying the visual element; and
extracting, by the data extraction component, the chart data from the code based on a markup language of the code.

3. The method of claim 1, further comprising:
identifying, by a categorization component, a plurality of chart categories; and
selecting, by the categorization component, the chart category from the plurality of chart categories using a rule-based heuristic.

4. The method of claim 3, further comprising:
determining, by the categorization component, that the chart data includes a temporal field and a numerical field, wherein the chart category comprises a time-series category.

5. The method of claim 3, further comprising:
determining, by the categorization component, that the chart data includes a nominal field and a numerical field, wherein the chart category comprises a distribution category.

6. The method of claim 3, further comprising:
determining, by the categorization component, that the chart data includes a set-relation field and a numerical field, wherein the chart category comprises a set-relation category.

7. The method of claim 1, further comprising:
identifying, by the insight detection component, a plurality of insight types corresponding to the chart category, wherein the plurality of insight types corresponds to a plurality of statistical measures, respectively; and
selecting the insight type from the plurality of insight types.

8. The method of claim 7, wherein:
the chart category comprises a time-series category, and the plurality of insight types includes aggregate statistics, cyclic patterns, trends, anomalies, or any combination thereof.

9. The method of claim 7, wherein:
the chart category comprises a distribution category, and the plurality of insight types includes aggregate statistics, grouped values, or any combination thereof.

10. The method of claim 7, wherein:
the chart category comprises a set-relation category, and the plurality of insight types includes aggregate statistics, grouped values, set comparisons, or any combination thereof.

11. The method of claim 1, further comprising:
generating, by the insight detection component, a plurality of insights based on the chart category, wherein the insight data corresponds to one of the plurality of insights;
ranking, by a filtering component, the plurality of insights; and
filtering, by the filtering component, the plurality of insights based on the ranking, wherein the insight caption is generated based on the filtering.

12. The method of claim 1, further comprising:
identifying, by the caption component, a plurality of sentence templates corresponding to a plurality of insight types; and
selecting, by the caption component, the sentence template corresponding to the insight type from the plurality of sentence templates.

13. A method for data processing, comprising:
receiving chart data from a data extraction component;
determining, by a categorization component, that the chart data corresponds to a distribution category;
generating, by an insight detection component, grouped values by grouping values of the chart data using a one-dimensional distribution clustering algorithm based on the determination;
generating, by a caption component, an insight caption by combining the grouped values with a sentence template corresponding to the distribution category; and
displaying the caption component in a user interface.

14. The method of claim 13, further comprising:
determining, by the insight detection component, that the chart data includes a nominal field and a numerical field, wherein the determination that the chart data corresponds to the distribution category is based on the nominal field and the numerical field.

15. The method of claim 13, wherein:
the one-dimensional distribution clustering algorithm satisfies a complete-linkage criterion.

16. The method of claim 13, further comprising:
sorting, by the insight detection component, a plurality of values of the chart data; and
selecting, by the insight detection component, a group for each of the plurality of values based on a minimum distance between a current value and values in a current group.

17. An apparatus for data processing, comprising:
a categorization component configured to select a chart category from a plurality of chart categories based on chart data using a rule-based heuristic;
an insight detection component configured to generate insight data for an insight type based on the chart data and the chart category using a statistical measure corresponding to the insight type;
a filtering component configured to filter a plurality of insights based on a ranking of the plurality of insights;
a caption component configured to generate an insight caption for the insight type based on the insight data and the filtering; and
a user interface configured to communicate the caption component to a user.

18. The apparatus of claim 17, further comprising:
a data extraction component configured to extract the chart data from code of a visual element of a display based on a markup language of the code.

19. The apparatus of claim 17, further comprising:
an audio component configured to generate an audible communication corresponding to the insight caption.

20. The apparatus of claim 17, wherein:
the insight detection component is further configured to perform a one-dimensional distribution clustering algorithm.
